(19) United States
(12) Patent Application Publication
(10) Pub. No.: US 2006/0134318 A1
(43) Pub. Date: Jun. 22, 2006

(54) Method of forming a conductive metal region on a substrate

(76) Inventors: Alan Hudd, HERTS (GB); Philip Bentley, Cambridge (GB); James Fox, Cambridge (GB); Martyn Robinson, Cambridge (GB)

Correspondence Address: MORGAN LEWIS & BOCKIUS LLP, 1111 PENNSYLVANIA AVENUE NW, WASHINGTON, DC, 20004, US

(21) Appl. No.: 10/543,311

(22) PCT Filed: Jan. 28, 2004
(86) PCT No.: PCT/GB04/00358

§ 371 Date: Jul. 26, 2005

Related U.S. Application Data
(60) Provisional application No. 60/527,948, filed on Dec. 8, 2003.

(30) Foreign Application Priority Data
Jan. 28, 2003 (GB) 0301933.8
Oct. 29, 2003 (GB) 0325247.5
Dec. 8, 2003 (GB) 0328221.7

(51) Int. Cl. B28B 19/00; B05D 5/12

(52) U.S. Cl. 427/98.4; 427/123

(57) ABSTRACT

There is disclosed a method of forming a conductive metal region on a substrate, comprising depositing on the substrate a solution of a metal ion, and depositing on the substrate a solution of a reducing agent, such that the metal ion and the reducing agent react together in a reaction solution to form a conductive metal region on the substrate.

The present invention relates to the field of forming conductive metal regions on substrates.

### BACKGROUND TO THE INVENTION

There are many industrial applications for conductive metal regions on substrates, particularly processes which enable the conductive metal regions to be formed according to a pattern. An important application is the manufacture of printed circuit boards, upon which metal layers are formed into a pattern to electrically connect different components and electrical devices according to a predetermined arrangement. Other applications include aerials and antennae, such as those found in mobile telephones, radio frequency identification devices (RFIDs), smart cards, contacts for batteries and power supplies, arrays of contacts for flat screen technologies (liquid crystal displays, light emitting polymer displays and the like), electrodes for biological and electrochemical sensors, smart textiles, and decorative features.

In most of these applications, the metal region must be conductive and a high level of conductivity is desirable, or in some cases essential.

One known method for preparing a conductive metal region on a substrate includes the step of inkjet printing a liquid including metallic nanoparticles. The printed liquid is then heated to fuse chemical components of the liquid and evaporate the solvent. The nanoparticles are thus brought into contact with each other and so conduct. However, these materials do not have a conductivity approaching that of bulk metal. The heating step is not only inconvenient, but prevents the technique from being used with low melting point plastic substrates.

One example of this technique is described in “Metallisations by Direct-Write Inkjet Printing”, presented at NCPV Program Review Meeting, Lakewood, Colo. 14-17 Oct. 2001, by C. Curtis et al. Digital inkjet printing techniques are used to print a pattern of metal organic decomposition inks, with and without nanoparticle additions. For depositing silver, an organometallic compound such as silver(hexafluoroacetylacetonate)(1,5-cyclooctadiene) is dissolved in an organic solvent to which silver particles are added which are sufficiently small to avoid clogging the 10-50 micron inkjet printing head orifice. The ink is then applied by a digitally controlled inkjet printer, which deposits an ink pattern across the substrate. The ink is then heated to form a pattern of nanoparticles, which provide the bulk of the conductivity, electrically joined to some extent by residual silver compounds. The technique provides good conductivity silver regions. However, the process is complicated for the preparation of copper regions by a need to operate in an inert atmosphere and the resulting copper films have resistivities which are several orders of magnitude worse than bulk copper metal. Although this technique provides a convenient means of preparing patterned metal layers on substrates, it requires an inconvenient annealing step and does not provide layers with conductivity close to that of bulk metal.

One technique which is known to provide metal layers with conductivity close to that of bulk metal is the electroless plating process. The electroless plating process is a solution chemistry plating technique which has been used for many years to apply a conductive metal coating layer to a substrate, which may be flat or shaped. A substrate is immersed in a succession of baths. The resulting conductive metal layer may be used as formed, or may undergo a subsequent electrodeposition process to increase the thickness of the conductive layer. A commercially important technique is the so-called “plate through hole” process which has been used for over 30 years to metallize drilled holes in printed circuit boards by electroless techniques, for subsequent electroplating.

A generic example of the electroless process is as follows. Firstly, a plastic substrate is etched in a chromic acid/concentrated sulphuric acid bath at 68±2° C. to microscopically etch the surface of the plastics substrate, ensuring good adhesion of the copper to the plastics substrate. Secondly, any hexavalent chromic species left on the plastics substrate are neutralised in a bath comprising approx. 30% concentrated hydrochloric acid at around 50° C. The plastics substrate is then added to a third bath in which an activator is added to prepare the plastics substrate surface to absorb the catalyst in the next step. This third bath is typically approx. 30% concentrated hydrochloric acid, at room temperature.

Next, the plastic substrate is dipped into a fourth bath which includes a dilute solution of a palladium colloid along with tin salts. The colloid deposits on the surface of the plastic to catalyse the deposition of copper in the subsequent plating step. This bath includes a high proportion of tin salts, approx. 30% concentrated hydrochloric acid, and operated at room temperature. The fifth bath into which the plastics substrate is dipped includes an accelerator which activates the adsorbed palladium, improving the speed and uniformity of deposition. Accelerator baths include around 30% concentrated hydrochloric acid.

Finally, the activated plastics substrate is dipped into a sixth bath including a plating solution which, catalysed by the palladium colloid on the plastic substrate, causes copper to deposit onto areas of the plastics substrate which were coated with the catalyst. The plating solution include a copper salt, formaldehyde as a reducing agent, and sodium hydroxide to activate the formaldehyde. The composition of the plating solution must be carefully temperature controlled, with a temperature of 45±2° C. being appropriate for some commercially applicable compositions. At a lower temperature, plating does not take place. At a higher temperature, plating takes places spontaneously and the copper in the bath plates out. The copper salt, formaldehyde and sodium hydroxide must be stored separately as the combined solution is unstable.

The electroless copper deposition is used extensively and has the important advantage of producing highly conductive metal layers. The conductivity of the resulting metal layer is usually close to that of the corresponding bulk metal.

However, a key disadvantage is that as plating is a bath process, the entire surface of the substrate is usually metallised. The process does not in itself allow the deposition of a metal in a pattern, as is required for many of the applications discussed above.

The process has several other limitations. Firstly, the process is relatively complex, often requiring at least 6 baths, and so is suitable only for use at specialist manufacturing facilities. Slight errors in composition or deviations from the optimum temperature can result in the majority of the copper in the plating solution spontaneously precipitating, wasting chemicals. Furthermore, the metal ions in the waste products can be toxic to the environment and so require expensive waste processing procedures. The high price of Palladium (and the volatility in the price of Palladium) lead to further high costs and economic uncertainty in catalysed procedures.

Several approaches to preparing a patterned metal layer by way of the electroless process have been described. Perhaps the simplest technique is to form the metal layer and then to apply a mask to parts of the metal layer which are to be retained, using an etchant to remove the remainder of the metal layer. This is wasteful of metal, laborious, of limited reproducibility and produces components of variable quality.

An alternative approach to providing metal parts according to a pattern is to press several component parts out of metal and then mount these into a device using additional substrate parts to hold the metallic components. The technology known as insert moulding has developed this concept, aiming to reduce the number of separate components and manufacturing costs. In insert moulding, a metal component is held inside an injection moulding machine and the part is then moulded around the metal component(s).

More recently, multi- and single-shot moulding technologies including plating have been developed. A first component is injection moulded in plastic and then plated with a metal by the electroless process described above. The plated part is then placed into a second mould and the remainder of the part is formed around the plated part.

A still further development is injection moulding incorporating two different grades of plastic, one of which is susceptible to plating in the electroless plating procedure, and one of which is not. Such parts are created in a single moulding process and then plated, with only the first grade of plastic being plated. Although effective, this process can be expensive and is therefore not suitable for use with low cost items.

U.S. Pat. No. 4,242,369 to Whittaker Corporation discloses compositions and processes for jet printing of a metal or alloy. Minute uniform droplets of a jet printing ink include at least one soluble salt of at least one plate metal. The process is limited to depositing metal on a base metal surface which is less noble than the plate metal.

U.S. Pat. No. 4,668,533 to E. I. Du Pont de Nemours and Company discloses inkjet printing on a substrate using an ink comprising either finely divided copper particles, or a metal containing activator, such as a palladium (II) salt. The resulting printed substrate is then placed in a metal depositing bath which deposits a metal layer by the electroless process described above. The pattern formed by the resulting metal layer is determined by the pattern of droplets applied during the inkjet printing stage.

U.S. Pat. No. 5,751,325 to AGFA-Gevaert, N. V. discloses an inkjet printing process which brings into working relationship, on a receiving material, a reducible metal compound, a reducing agent for said metal compound and physical development nuclei that catalyse the reduction of said metal compound to metal. The process is used to produce high optical density inkjet printed images rather than a conductive metal layer. The physical development nuclei are dispersed in an image receiving layer, such as a gelatin layer, overlying a substrate. Thus, metal is formed as discrete particles, around each physical development nuclei, within the gelatin layer. Discrete particles will not form an electrically conductive region.

It is known to print conductive carbon (e.g. graphite) ink, or a conductive polymer, such as PEDOT, on a substrate and to then electrolytically plate the substrate. However, this is a complicated multistage process.

It is also known to generate a conductive polymer on a substrate by printing a polymer, oxidising the polymer with permanganate and then reacting the oxidised polymer with pyyrole to produce conductive polypyrrole. This resulting material has low conductivity compared with conductive metals and so a subsequent electrolytic plating step may be applied. Again, this is a complex multistage process.

### SUMMARY OF THE INVENTION

According to a first aspect of the present invention, there is provided a method of forming a conductive metal region on a substrate, comprising depositing on the substrate a solution of a metal ion, and depositing on the substrate a solution of a reducing agent, such that the metal ion and the reducing agent react together in a reaction solution to form a conductive metal region on the substrate.

It is not known precisely where the reaction between the metal ion and the reducing agent takes place; however, the reaction preferably takes place on or near or within the surface of the substrate, i.e. in situ, and not before the metal ion and reducing agent are in contact with the surface of the substrate.

Preferably, the metal which is deposited is the only or uppermost metal layer in a product. Thus, the invention can be used to deposit all, or the bulk of, the metal which is to form the conductive metal region in a finished product.

Unlike the method disclosed in U.S. Pat. No. 5,751,325, there is no requirement for physical development nuclei. The metal ion and the reducing agent react together in the reaction solution and form a conductive metal region on the substrate, instead of forming discrete fine metal particles away from the substrate.

The reaction solution must have a composition such that the formation of a conductive metal region on the substrate is thermodynamically favourable. A conductive metal region will build up on the substrate and catalyse further growth of the conductive metal region.

Whether this is thermodynamically favourable will depend on factors including the temperature and pH of the reaction solution, the strength of the reducing agent, the ease with which the metal ion can be reduced, the influence of complexing agents which can slow down the reduction of the metal ion, the properties of additional components of the reaction solution and other factors well understood by persons skilled in the field.

However, the composition of the reaction solution should not be such that spontaneous formation of metal particles takes place throughout the reaction solution. If this occurs, then instead of building up a conductive metal region on the substrate, fine particles will form which are not physically connected to the surface of the substrate or electrically connected to one another.

Deposition of solution on the substrate allows the amount of metal ion and reducing agent to be commensurate with the desired thickness of the conductive metal region. Deposition contrasts with immersion techniques such as the conventional electroless process where the substrate is immersed in a bath including metal ion and reducing agent. Deposition requires lower quantities of metal ion and reducing agent than an immersion process and can reduce waste. Furthermore, deposition reduces or obviates the difficulties in regulating the composition and temperature of immersion baths.

The composition of the reaction solution may be selected so that it is sufficiently unstable that the reaction between metal ion and the reducing agent in solution to form the conductive metal region on the substrate takes place spontaneously. However, the reaction solution should not be composed so that it is so unstable that a fine powder of conductive metal forms spontaneously throughout the reaction solution, instead of forming a conductive metal region on the substrate.

One skilled in the art can readily adjust the composition of the reaction solution to prepare a reaction solution which will spontaneously plate out on the substrate, but not throughout the reaction solution.

The reaction between the metal ion and the reducing agent in solution to form the conductive metal region on the substrate may be activated by an activator. In this case, the reaction between the metal ion and the reducing agent to form the conductive metal region on the substrate need not take place spontaneously were it not for the presence of the activator.

The activator may already have been applied to the substrate. The activator may be a component of the substrate. The activator may be applied to, preferably deposited on, the substrate as an initial stage.

Preferably the activator is a catalyst which catalyses the reaction between the metal ion and the reducing agent. Appropriate catalysts lower the activation energy and allow the metal region to form spontaneously on the substrate.

Preferred activators include fine metal particles or a metal layer (which functions as catalyst). The activator may comprise a component of a reaction which forms fine metal particles or a metal layer in situ, for example metal ions or reducing agent which can react in a reaction solution of metal ions and reducing agent to form fine metal particles or a metal layer which functions as a catalyst for the subsequent metallisation reaction. In this case the metal which comprises the activator is typically different to the metal which forms the bulk of the conductive metal layer in the finished product. For example, an organic acid salt of a transition metal, such as palladium acetate may be deposited (preferably inkjet printed), preferably with one or more binders, then reduced to palladium in situ by application of reducing agent (preferably by inkjet printing, but potentially by any metallisation process including immersion in a bath of reducing agent). A solution of a different metal ion, e.g. copper, nickel or silver ions, is then deposited thereon, as is a solution of a reducing agent, by the method of the present invention. Preferably, the resulting reaction solution is autocatalytic, i.e. once its component metal starts depositing, further metal will deposit thereon. The catalyst metal functions to catalyse the formation of metal from the autocatalytic solution thereon, to start the deposition process.

Suitable activators include organic acid salts of transition metals, for example, palladium acetate or palladium proponate. Palladium acetate has been found to have good solvent solubility, is readily printable by inkjet techniques, and dries quickly to give high print quality and good edge definition. Many other palladium salts, such as palladium chloride, are also suitable. Alkanoate salts are preferred. Alternative activators include salts, complexes or colloids of transition metals, or particles of bronze, aluminium, gold or copper.

A suitable solvent for the deposition of an organic acid salt of a transition metal is a 50/50 mixture of diacetone alcohol and methoxypropanol. Preferably, the organic acid salt of a transition metal constitutes 1-3% by weight of palladium acetate, most preferably 2% by weight of the deposited liquid. An equivalent concentration of another organic acid salt of a transition metal can be employed.

An alternative solvent is a 50/50 mixture of toluene and methoxypropanol. Approximately a 2 % by weight solution of palladium acetate in this solvent is preferably. Preferably a co-solvent is added to increase viscosity for inkjet printing.

The activator/catalyst may be a second metal different from the first metal. The second metal may be formed by depositing ions of the second metal and a reducing agent on the substrate, such that the second metal ions and the reducing agent react together in a reaction solution to form a conductive metal region on the surface. In this case, the first metal will preferably form the bulk of the conductive metal which is deposited.

A catalytic metal region, or fine metal powder may be formed by first depositing (preferably by inkjet printing) of one or more of metal ion, reducing agent or base, preferably with a binder or in a chemical formulation which forms a solid layer, and then depositing whichever of metal ion, reducing agent and base has not already been deposited thereon. This forms a conductive metal region or an area of fine metal particles.

In one embodiment a metal ion (e.g. palladium) is applied to the substrate by inkjet printing (and preferably dried/cured/hardened in situ) and then the substrate is either immersed into a bath of reducing agent or has reducing agent deposited thereon (e.g. by inkjet printing) forming a conductive metal region or area of fine metal particles on the substrate to function as catalyst. This is then suitable for metallisation by deposition on the substrate of a solution of a metal ion, and deposition on the substrate of a solution of a reducing agent as before. Typically, the metal ion deposited to form the bulk of the resulting conductive metal region is different to the metal ion deposited to form the catalyst. In alternative embodiments, reducing agent is applied first to the substrate, which is then immersed in a solution of metal ion and base or has metal ion deposited thereon by inkjet printing.

Whether or not an activator is required, the solution of metal ion and the solution of reducing agent may be deposited in a plurality of separate component solutions, or in a single component solution.

A pH altering reagent, typically an acid or base may also be deposited, to activate the reducing agent. The acid/base may be deposited in a component solution with either or both of the metal ion and the reducing agent. The base may deposited in a separate component solution to either or both of the metal ion and the reducing agent. The acid/base may also be deposited with the activator. Thus, the metal ion may be stored in a component solution at a pH at which it will not spontaneously form metal.

For example, the metal ion, the reducing agent and an acid/base may be deposited in three separate component solutions which mix together on the substrate and form the reaction solution.

In another example, the metal ion and the reducing agent are deposited in a first component solution, and an acid/base is deposited in a second component solutions, such that the first and second component solutions mix together on the substrate and form the reaction solution.

In a further example, a single component solution includes the metal ion, the reducing agent and the acid/base.

It is generally preferred to have as few component solutions as possible to minimise the complexity of the deposition process. However, where the reaction solution is not sufficiently stable to be used reliably with the chosen deposition process, the separation of components of the reaction solution into a plurality of component solutions allows the reaction solution to be prepared from more stable component solutions.

Where an activator is used, the method preferably includes the step of depositing the activator on the substrate before deposition of a component solution. More preferably, the activator is deposited before either or both of the metal ion or the reducing agent are deposited on the substrate. The activator is therefore located on the substrate and so favours formation of a conductive metal region on the substrate rather than formation of fine particles of conductive metal throughout the reaction solution.

The activator is preferably deposited in an activator solution. Preferably, the solvent for the activator solution is primarily or entirely non-aqueous. The solvent is preferably allowed to substantially evaporate or otherwise dissipate prior to deposition of one or more component solutions thereby forming a layer. This reduces or prevents diffusion of the activator away from the substrate where it might lead to excessive formation of conductive metal regions which are not on the substrate. Typically, between a few seconds and a few minutes may be required to allow volatile components to dissipate, with a time of around 30 seconds being typical, before one or more component solutions are deposited thereon.

Optionally, the substrate is pretreated before an activator liquid is deposited thereon. This causes the activator liquid to dry rapidly and spread less, achieving thinner lines. For example, a Melinex substrate (Melinex is a Trade Mark) was heated at 350° C. for 4 seconds using a heat gun.

Preferably, the activator is deposited in a solution including a chemical component which promotes adhesion of the activator to the substrate, for example, a polymer. Suitable adhesion promoters retain the activator on the surface of the substrate so that the activator is not washed into the reaction solution when a further component solution is deposited. Suitable polymer adhesion promoters include polyvinylpyrollidinone and polyvinylbutyral.

Where, as is preferred, the activator is deposited in a primarily or entirely non-aqueous solution, the activator may be deposited in a solvent selected dependent on the nature of the substrate. Preferably, the solvent is selected to partially dissolve the substrate to enable the activator to penetrate the substrate and improve adhesion of the resulting conductive metal region to the substrate. Thus, the activator is preferably deposited in solution prior to the deposition of either or both the metal ion and the reducing agent. However, the solvent must not be too aggressive or not only will the substrate be damaged, but the substrate will swell and the activator will penetrate too far into the substrate, so that it is no longer present at the surface of the substrate in sufficiently quantity to reliably activate the deposition of the conductive metal ions.

The substrate may be pretreated prior to the deposition of activator to improve adhesion. For example, the substrate may be immersed in a water based oxidising solution, as it known in the conventional electroless procedure. The method may also include the deposition of a preparation reagent on the substrate, such as a solvent which etches the substrate or a water based oxidising solution, prior to deposition of the catalyst.

The activator solution may comprise one or more of the metal ion, the reducing agent or a base/acid.

The component solution which comprises the metal ion may further comprise a complexing agent. A complexing agent such as EDTA binds metal ions, slowing or preventing the rate of reduction of the metal ion by the reducing agent. A complexing agent can therefore prevent spontaneous formation of metal in the component solution comprising the metal ion.

A single component solution may be deposited, or a plurality of component solutions may be deposited which are mixed together during or as a result of deposition. If metal ion and reducing agent are deposited at separate times, they may be deposited in either order. Where a plurality of component solutions are deposited, they may be deposited sequentially or simultaneously. It is preferred that a plurality of component solutions are deposited sequentially and a single solution, or combination of solutions is allowed to partially or fully dry-out, cure or otherwise harden before one or more further component solutions are deposited thereon. We have found that this procedure can allow better adhesion of the conductive metal region to the substrate and can improve the quality of patterning.

Where a solution (perhaps formed from a plurality of solutions) (hereafter ‘first liquid’) comprising an activator for the conductive metal region forming reaction, is allowed to partially or fully dry-out, cure or otherwise harden on the substrate to form a first solid layer, before one or more further component solutions (hereafter ‘second liquid’) is deposited thereon to begin the conductive metal region forming reaction, and where the first liquid comprises an activator for a second solid-layer-forming chemical reaction, the first liquid is selected so that the first solid layer adheres to the substrate and is permeable to the second liquid which comprises one or more reagents for the second solid layer-forming chemical reaction.

Thus, the activator is adhered to the substrate by virtue of its inclusion in the first solid layer (whether by entrapment, immobilisation or other means).

When the second liquid is brought into contact with the first solid layer, the second liquid penetrates the first solid layer, allowing the second liquid to access the activator within the first solid layer. The second solid-layer-forming reaction can thus take place, on or in close proximity to or within the substrate substance, producing the desired (second) solid layer (of conductive metal) on the substrate. Furthermore, penetration of the second liquid into the first solid layer may result in the (second) solid layer of material intermingling with the first solid layer, thereby enhancing adhesion of the (second) solid layer (of conductive metal) to the substrate via the adhered first solid layer.

As the activator is located in a layer on the surface of the substrate, metallisation will occur on the first layer in preference to the formation of fine particles of metal in the second liquid.

The first liquid need not necessarily be a solution. One or more components thereof may be a solid, colloid etc.

Preferably, the first liquid comprises a first chemical functionality which is insoluble in the second solvent.

Preferably also, the first liquid comprises a second chemical functionality which is at least partially soluble in the second solvent. Such a second chemical functionality will at least partially dissolves in the second solvent, allowing the second solvent to penetrate the first solid layer and contact the activator. The first chemical functionality retains sufficient integrity to adhere to the substrate and the second solid layer.

The method may include the further step of chemically converting the one or more reagents to an active or catalytic form. For example, palladium acetate may be reduced in situ by a subsequently applied reducing agent solution, forming palladium metal which can catalyse deposition of metal thereon when the second liquid is applied.

The first liquid may comprise a second chemical functionality which can swell in the second solvent or take up the second solvent.

The first and second chemical functionalisation may be separate molecules, or groups of molecules, or may be or become part of the same molecules. Typically, they are two separate binders.

The first chemical functionality only needs to be sufficiently insoluble in the second solvent to retain integrity while the second solid layer is formed. Also, the first solvent is preferably sufficiently aggressive to the substrate to allow the first layer to allow the first liquid to penetrate therein, increasing adhesion of the first solid layer to the substrate, and thus also increasing the adhesion of the second solid layer to the substrate (via the first solid layer).

The first and second solvents are preferably different. This allows the first solvent to be selected to be appropriate for the formation of the first layer and the adhesion of the first layer to the substrate, whilst the second solvent can be selected to be appropriate for the formation of the second layer. Preferably, the second solvent is water. Preferably also, the first solvent is selected to partially dissolve or otherwise permeate into the substrate, improving adhesion of the first layer to the substrate. Thus, aqueous metallisation chemistry and a non-aqueous first solvent can be utilised in different steps of the same process. Preferably, the first solvent is partially or entirely non-aqueous.

Thus, the first liquid may comprise one or more second chemical functionalities which are soluble in the second solvent, such as polyvinyl pyrrollidinone, which is soluble in water. Alternatives include polyacrylic acid, polyvinyl acetate, polyethylene imine, polyethylene oxide, polyethylene glycol, gelatin or copolymers thereof. The soluble components may dissolve when the second liquid is brought into contact with the first solid layer. For example the polyvinyl pyrrollidinone will dissolve in contact with an aqueous solution of metal ion and reducing agent usable to form a conductive metal region on the first solid layer. Around 5% by weight of polyvinyl pyrrollidinone in the resulting solid layer is appropriate.

The second chemical functionality could instead (or as well) comprise a water swellable monomer and/or oligomer such as HEMA (2-hydroxyethyl methacrylate), GMA (glyceryl methacrylate) or NVP (n-vinyl pyrrolidinone). Other monomers and/or oligomers which are themselves swellable in the solvent of the second liquid and/or are swellable when polymerised could be used instead. This allows the second liquid to permeate into the first solid layer, improving adhesion and allowing access to more activator than just what is present on the surface of the first solid layer.

The second chemical functionality could instead (or as well) comprise a high boiling point solvent miscible with the solvent of the second liquid. For example, NMP (n-methyl pyrrolidinone) could be used when the second liquid is aqueous. This keeps the resulting polymer matrix open in the first solid layer allowing penetration by the second liquid and improving the adhesion of the second solid layer to the first solid layer. Alternative solvents include ethylene glycol, diethylene glycol or glycerol.

The first liquid could instead (or as well) comprise micro-porous particles to create a micro-porous film structure. Micro-porous particles could be organic (e.g. PPVP poly (polyvinyl pyrrolidinone)) or inorganic (e.g. silica).

The first liquid may solidify as a result of evaporation of the first solvent.

The process may be repeated (optionally with different first and second liquids) to build up a multi-layer structure.

Preferably, the first liquid is curable; that is to say, able to undergo a chemical change as a result of which the liquid hardens, preferably solidifies

The curable first liquid may be selected to have improved wetting properties on one or more substrates than the second liquid. This allows more accurate and precise patterning than if the curable first liquid was applied from the same carrier (e.g. water) as the second liquid, with fine features and better edge definition. There will typically be less bleed and feathering of the curable first liquid than if activator were applied to the surface by a different technique using a carrier with poorer wetting properties. Improved wetting properties allow more accurate and precise patterning as successive spots of liquid along a line can be deposited further apart (by a technique such as inkjet printing) allowing a lower volume of liquid to be used, and thus narrower lines and finer features to be prepared.

This use of the first curable liquid comprising an activator is particularly important where it is desirable to use inkjet printing to digitally pattern a material on a substrate. Many curable liquids are within the correct viscosity range to be inkjet printed.

The curable first liquid preferably comprises one or more component chemicals which can undergo a reaction causing the liquid to harden.

Preferably, the curable first liquid comprises monomers and/or oligomers which can polymerise and/or cross-link in use, thereby hardening and forming a solid layer. Preferably, the resulting polymer forms a matrix which includes the activator. A curable first liquid including at least some oligomers will often have lower toxicity than if it included only monomers.

The first solid layer may be rigid, elastic or plastic (where or not it is formed by curing). Preferably, it need not necessarily finish hardening before the second liquid is applied.

Preferably, the first liquid is curable in response to a stimulus, for example, electromagnetic radiation of a particular wavelength band (e.g. ultra-violet, blue, microwaves, infra-red), electron beams, or heat. Thus, the curable first liquid may be curable responsive to electromagnetic radiation of a specific wavelength range (e.g. ultraviolet radiation, blue light, infra-red radiation), heat curable, electron beam curable etc. The liquid could be curable responsive to the presence of one or more chemical species such as moisture or air. Preferably, the component chemicals are selected to undergo a reaction responsive to one of the above stimuli.

Typically, the curable first liquid comprises one or more monomers and/or oligomers which can form a polymer, and constitute the first chemical functionality. For example, monomers and/or oligomers which react to form a polymer, and an initiator which starts a polymerisation reaction responsive to one of the above stimuli. e.g. AIBN (2,2′-azobisisobutyronitrile) can be included to initiate a polymerisation reaction responsive to heat. Typically, an initiator generates free radicals responsive to a stimulus. It is also possible to use an initiator which generates cations responsive to a stimulus.

Preferably, the monomers and/or oligomers are those known from the field of UV curable, or other curable inks proposed for inkjet printing of curable inks.

Preferably, the delay between depositing and curing the curable liquid is as short as possible. This reduces over-wetting of the substrate, which causes less of definition to the image. Preferably the delay between deposition and curing is 20 seconds or less.

Preferably, the curable first liquid comprises some monomers and/or oligomers having a high number of cross-linkable functional groups, such as four or more, or even six or more functional groups. For example, Actilane 505 (which is a reactive tetrafunctional polyester acrylate oligomer supplied by AKZO Nobel UV Resins, Manchester, UK) is suitable, as is DPHA (dipentaerythritol hexaacrylate) which is a hexafunctional monomer supplied by UCB, Dragenbos, Belgium. These monomers and/or oligomers with a high number of cross-linkable functional groups are more highly cross-linked than polymers formed from monomers with fewer cross-linkable functional groups and can provide a stronger, more robust film with better adhesion to the substrate. Too high a proportion of highly cross-linkable monomers and/or oligomers would however form a brittle surface.

As the activator is also included in the first liquid it will typically be trapped within the first layer in a matrix formed, for example, by a polymer. The activator could also be immobilised as part of the matrix, for example, by including the activator on a molecule with a reactive group which reacts with monomer or oligomer units. The activator may be initially inactive, and become active only once the first liquid has formed the first solid layer, or in response to a stimulus, or when in contact with a component of the second liquid.

Where the second solid-layer-forming chemical reaction is to be a reaction between metal ions and a reducing agent, to form a conductive metal region, the activator may be one or more of metal ions, reducing agent and (optionally) an acid or base. The second liquid will be such that a second-layer-forming reaction begins when the second liquid is in contact with the first layer. Where the activator comprises metal ions, typically as metal salts or metal complexes (and perhaps also bases), the second liquid may comprise reducing agent and (optionally) an acid/base. The second liquid may also contain additional ions of the same or a different metal. Where the activator comprises a reducing agent (and perhaps also acid/base), the second liquid will preferably comprise metal ions, typically as metal salts or metal complexes. The second liquid may comprise further reducing agent. Where the activator comprises base, the second liquid typically includes metal ions and reducing agent, and optionally further acid/base.

Where the first liquid is curable, it preferably does not include a volatile carrier which, in use, is evaporated off before the second liquid is brought into contact with the first layer. Thus, substantially all of the constituents of such a curable first liquid preferably remain (albeit perhaps in chemically changed form) in the first solid layer.

However, the first liquid may include a volatile carrier. Typically, in use, some or all of the volatile carrier evaporates or is evaporated off before the second liquid is brought into contact with the first layer. For example, the first liquid may comprise water or (preferably) one or more organic solvents which, in use, are evaporated off before the second liquid is brought into contact with the first layer. The method may include a pause to allow a volatile carrier to evaporate before one or both of applying a stimulus (if applicable) and bringing the second liquid into contact with the first layer.

Preferably, the first liquid is deposited onto the substrate by inkjet printing. Preferably, the second liquid is deposited on the first layer by inkjet printing. Where the first liquid and/or resulting first layer are patterned, the second liquid may be deposited according to the same pattern.

A component solution may be mixed from stock solutions prior to deposition. Mixing may take place immediately prior to deposition. For example, a component solution which is unstable might be mixed from stock solutions including constituents of the component solution prior to deposition. More particularly, a component solution including both the metal ion and the reducing agent might be mixed from separate stock solutions of the metal ion and the reducing agent immediately prior to deposition. This allows unstable solutions to be deposited onto the substrate.

It is generally preferred initially to deposit on the substrate a component of the reaction (in the form of a solution of a metal ion, a solution of a reducing agent or an activator) and for that component to dry, cure or otherwise harden to form a solid layer on the substrate. Other component(s) of the reaction are subsequently deposited in liquid form (in one or more steps) on the solid layer.

A currently preferred method involves initial deposit of an activator, e.g. palladium acetate, which is dried, cured or otherwise hardened in situ to form a solid layer on the substrate surface. The palladium acetate is optionally treated with DMAB (dimethylamineborane) to reduce palladium ions to palladium metal. A solution of a metal ion, e.g. copper sulphate, and a reducing agent, e.g. formaldehyde, (with base to adjust pH) are then deposited on the palladium metal layer, with these further reagents conveniently mixed together in a single solution.

Preferably, the activator is deposited on the substrate in a pattern, thereby leading to the formation of one or more patterned conductive metal regions. Component solutions may be deposited in the same pattern, over the activator, or more generally across the substrate.

A pattern may also be formed by depositing a component solution in a pattern. This is particularly appropriate where activator has been deposited in a non-pattern specific distribution across the substrate.

Preferably, deposition in a pattern is carried out by inkjet printing. Preferably, the activator solution is inkjet printed. Alternatively or as well, one or more component solutions may be inkjet printed. Other deposition techniques, such as spraying, may be employed.

Inkjet printing can be used to provide a quicker process, with fewer steps, than the conventional electroless procedure. Inkjet printing apparatus could potentially be cheaper than the capital equipment required for the conventional electroless procedure and is more readily transported than the immersion baths used in the conventional electroless procedure. Inkjet printing allows the deposition of very carefully controlled volumes of liquid, allowing the correct stochiometry of metal ion and reducing agent to be deposited, reducing waste. For example, where the metal ion is copper sulphate and the reducing agent is formaldehyde, the reaction products are sodium sulphate and sodium formate which can readily be processed for disposal. Thus, substantially stochiometric amounts of metal ion and reducing agent may be deposited. Preferably, however, an excess of reducing agent to metal ion may be deposited, so that essentially all of the metal ion is consumed, reducing or avoiding metal-containing waste. The excess reducing agent may be washed away.

Another benefit of inkjet printing is that it is a digitally controlled procedure, allowing different patterns to be applied using the same apparatus. This is particularly important for one-off products, customised products, or a series of uniquely identifiable products.

Furthermore, as inkjet printing is a non-contact procedure, the present method may be used with fragile substrates.

Inkjet printing may be achieved using continuous or drop-on-demand inkjet printing techniques, such as binary or raster continuous inkjet, and piezo or thermal drop on demand inkjet technologies. For example, U.S. Pat. No. 5,463,416 discloses a method of operating a drop-on-demand inkjet printer.

Where an acid or base is used, the inkjet print head preferably comprises a ceramic material, such that liquid containing the acid or base contacts only ceramic material in the inkjet print head.

Where there are a plurality of solutions to be inkjet printed, these may be deposited by different nozzles or banks of nozzles in the same inkjet head, or by separate inkjet heads at the same time, or after a short delay.

The metal ion may be an ion of any conductive metal. Preferred conductive metals include copper, nickel, silver, gold, cobalt, a platinum group metal, or an alloy of two or more of these materials. The conductive metal may include non-metallic elements, for example, the conductive metal may be nickel phosphorus.

The metal ion is typically in the form of a salt. For example, copper sulphate. The metal ion might instead be present in a complex such as with EDTA (ethylene diamine tetra acetic acid) or cyanide.

Examples of appropriate reducing agents are formaldehyde, glucose or most other aldehydes, or sodium hypophosphite, glyoxylic acid, hydrazines or dimethylamineborane. A relatively mild reducing agents may be used with readily reducible metal ions such as gold or silver, and stronger reducing agent may be required for less readily reducible metal ions. The reducing agent should not be too strong however or metal particles will spontaneously nucleate away from the surface of the substrate.

The substrate and/or the reaction solution may be heated to start and/or speed up the process of deposition of conductive metal on the substrate. For example, infra-red light from an infra-red heater may be incident on the reaction solution.

Suitable substrates include plastics material sheets and fabrics. The substrate might be a material having thereon electrical components, such as conductive, semiconductive, resistive, capacitive, inductive, or optical materials such as liquid crystals, light emitting polymers or the like. The method may include the step of depositing one or more of said electrical components on a substrate, preferably by inkjet printing, prior to forming a conductive metal region on the resulting substrate.

Similarly, the method may further include the step of depositing an electrical component onto the resulting conductive metal region, building up complex devices. Said further deposition step may also be carried out using inkjet printing technology.

Thus, the method can be used as one stage in the fabrication of electrical items. It is particularly appropriate for use in manufacturing electrical items which involve complex patterns, such as displays which include complex patterns of pixels. Other applications include the fabrication of aerials or antenna for car radio, mobile phones, and/or satellite navigation systems; radio frequency shielding devices; edge connectors, contact and bus connectors for circuit boards; radio frequency identification tags (RFID tags); conductive tracks for printed circuit boards, including flexible printed circuit boards; smart textiles, such as those including electrical circuits; decoration; vehicle windscreen heaters; components of batteries and/or fuel cells; ceramic components; transformers and inductive power supplies, particularly in miniaturised form; security devices; printed circuit board components, such as capacitors and inductors; membrane keyboards, particularly their electrical contacts; disposable low cost electronic items; electroluminescent disposable displays; biosensors, mechanical sensors, chemical and electrochemical sensors.

Preferably, the conductive metal region forms a layer. Preferably, components of the reaction solution are selected so that the layer adheres to the surface of the substrate. The method may be repeated, depositing further metal ion and reducing agent in solution upon the conductive metal region so as to form a thicker conductive metal layer. Different metal ions may be used for a second or successive layers, thus building up a material comprising layers of a plurality of different metals. Products including multiple layers of different metals may be built up in this way, including products comprising layers alternative between two or more different metals. Alloys may be built up by depositing a component solution comprising a mixture of metal ions, or by depositing a plurality of component solutions comprising different metal ions.

A preferred application of the method is as one or more steps in the fabrication of radio frequency identification tags (RFID tags). RFID tags can send and/or receive identifying information to/from RFID tag detectors. The method is applicable to both inductively and capacitively coupled tags, which may be active (i.e. including an internal power source) or passive (not including an internal power source). Such tags typically include a microprocessor (often including some memory), and a conductive antenna.

The invention extends to a method of manufacturing an RFID tag using one or more of the procedures A, B or C below, and also to an RFID tag manufactured using one or more of procedures A, B or C below.

In procedure A an antenna of a conductive metal is formed on a substrate by the method of the first aspect. Preferably, the antenna is a concentric loop of conductive metal. This technique is applicable to the manufacture of active or passive RFID tags. The invention also extends to a method of forming an aerial on a substrate (for any application) by forming a conductive metal region, configured to function as an aerial, on a substrate, by the method of the first aspect.

In procedure B a battery is formed on a substrate by forming two regions of different conductive metals on a substrate by the method of the first aspect, and electrolytically connecting the two regions by way of an electrolyte (which may be inkjet printed), thereby forming an electrochemical cell. A plurality of electrochemical cells may be electrically connected in series or in parallel thereby increasing the voltage and/or current available. The invention also extends to a method of forming a battery by forming two regions of different conductive metals on a substrate by the method of the first aspect, and electrolytically connecting the two regions by way of an electrolyte (which may be inkjet printed). The invention also extends to a battery formed by the said method.

In procedure C a microchip is applied to a substrate and then one or more conductive metal regions are formed on the substrate by the method of the first aspect of the present invention to make electrical connections to one or more electrical contacts of the microchip. The invention also extends to a method of making an electronic device (not just RFID tags) comprising the step of applying a microchip to a substrate and then forming one or more conductive metal regions on the substrate by the method of the first aspect of the present invention. The invention further extends to an electronic device made by this method.

Preferably, this procedure includes the step (after the microchip has been applied to the substrate) of measuring the location of the microchip and then forming the conductive metal regions to make electrical connections dependent on the measured location of the microchip. This has the benefit that the location where the microchip is applied can vary within a tolerance that is higher than with known methods of locating a microchip, reducing costs.

The procedure may also include the step of forming a conductive metal region on the substrate to function as a heat sink for a microchip, before applying the microchip thereon. Preferably also, the method includes the step of depositing a thermally conductive material (typically a thermally conductive adhesive) upon the heat sink (perhaps by inkjet printing) before the microchip is applied.

In procedures A, B and C above, a region of Conductive metal is preferably formed on a substrate by inkjet printing.

The method of manufacturing an RFID tag may comprise the steps of inkjet printing the substrate upon which the antenna, battery, heat sink and/or chip is deposited.

The method of manufacturing an RFID tag may comprise the step of inkjet printing an over coat or protective layer of material (such as a polymer layer) over the deposited components.

The method of manufacturing an RFID tag has advantages of simplicity and low cost over known techniques.

The one or more component solutions should fulfil the specific requirements of inkjet printing inks as regards viscosity, surface tension, conductivity, pH, filtration, particle size and ageing stability. Humectants may be added to one or more component solutions to reduce evaporation. The particular values of these properties which are required are different for different inkjet technologies and suitable component solutions fulfilling these properties can readily be devised for a specific application by one skilled in the art.

The method may include the further step of electrolytically plating additional metal onto the conductive metal regions by known electrolytic plating techniques. The method may include the further step of plating additional metal onto the conductive metal regions by the known electroless immersion procedure.

Alternatively, a sufficient amount of conductive metal may be formed on the substrate that no further step of plating additional metal by known electrolytic or electroless immersion procedures is required.

According to a second aspect of the present invention there is provided an article comprising a substrate including a conducting metal region prepared according to the method of the first embodiment.

Preferably, the conducting metal region is a layer.

According to a third aspect of the present invention there is provided a method of activating the reaction between a metal ion and a reducing agent to form a conducting metal region comprising the use of an organic acid salt of a transition metal as an activator.

Many organic acid salts of transition metals have good solvent solubility, are readily printable by inkjet techniques, and dry quickly to give high print quality and good edge definition. A preferred organic acid salt of a transition metal is palladium acetate which has the above properties and also has the benefit of being commercially available in bulk at a reasonable price. Alternatives include palladium propanoate, butanoate etc. or other alkanoate salts of a transition metal, especially palladium.

In use, the organic acid salt of a transition metal is reduced to metal particles or a metal layer which can catalyse deposition of metal (preferably a different metal) thereon, by the method of the first aspect.

Preferably, the activator is deposited with a polymer to adhere the catalyst to the substrate.

Preferably, the activator is added to a substrate and the conducting metal region is formed as a layer on the substrate.

Preferably also, the activator is added to the substrate by inkjet printing a solution including the activator.

### DETAILED DESCRIPTION OF AN EXAMPLE EMBODIMENT

The following activator solution is prepared:

Activator Solution

| | % - by weight |
|---|---|
| palladium acetate | 2.0 |
| diacetone alcohol | 47.7 |
| methoxy propanol | 47.7 |
| polyvinylbutyral | 1.6 |
| potassium hydroxide | 1.0 |

Palladium acetate is present as an activator. Diacetone alcohol and methoxy propanol are mixed in this proportion to give a solvent which evaporates sufficiently quickly to allow the palladium acetate to attach to the substrate before addition of the reaction solutions discussed below. However, the rate of evaporation is sufficiently slow that this activator solution can be conveniently inkjet printed. Polyvinylbutyral is present to help the catalyst adhere to the substrate. Polyvinylbutyral with a molecular weight of between 15,000 and 25,000 is suitable, such as grade BN18, available from Wacker. Potassium hydroxide is present to function as a base, activating the reducing agent below.

To make the above activator solution, a 30% solution of polyvinylbutyral is prepared in a 50/50 mixture by weight of diacetone alcohol and methoxy propanol. A 3% palladium acetate solution is prepared in the same solvent mixture using sonication over a period of 2-3 hours. Separately, a 10% solution of potassium hydroxide is prepared in the same solvent mixture. These three solutions are then mixed and more of the same solvent mixture is added to make up the appropriate total volume to give the proportions specified above. The resulting fluid is brown-orange translucent liquid which is then filtered through a 1 micron GF-B glass fibre filter available from Whatman. A slight deposit is sometimes visible on the filter paper.

The resulting activator solution has a viscosity of 3.91 cPs and a surface tension of 31.5 dynes/cm.

The following three component solutions are also prepared:

Solution A

| | % - by weight |
|---|---|
| copper sulphate | 1.63 |
| sodium sulphate | 3.21 |
| EDTA, disodium salt | 0.60 |
| water | 89.56 |
| t-butanol | 5.00 |

The copper sulphate is the source of the metal ion, here Cu²⁺. Sodium sulphate is present to stabilise the copper sulphate. EDTA is a complexing agent which forms a protective barrier around the copper ions, without which a solution of this composition would immediately precipitate out. t-butanol is a cosolvent which reduces surface tension and improves wetting.

Solution B

| | % - by weight |
|---|---|
| formaldehyde solution (37% by weight in water) | 0.22 |
| sodium formate | 3.71 |
| water | 91.07 |
| t-butanol | 5.00 |

Formaldehyde is present as the reducing agent.

Solution C

| | % - by weight |
|---|---|
| sodium hydroxide | 1.74 |
| water | 93.26 |
| t-butanol | 5.00 |

The function of sodium hydroxide is to activate the reducing agent when the solutions are combined.

Solutions A, B and C are shaken and then filtered through a 1 micron GF-B glass fibre filter, available from Whatman. Each solution had a viscosity of less than 3 cps.

Deposition

Firstly, the activator was deposited by inkjet printing. An XJ128-200 print head, from Xaar, was primed with the activator solution and then used to jet the activator solution onto the substrate. The resolution down web was adjusted to the particular substrate. For easily wetted substrates, 250 dots per inch (dpi) was used. For substrates which are wetted only with difficulty, 1000 dpi was used to ensure complete wetting.

The XJ128-200 print head ejected droplets of 80 pL. The jetting frequency was between 1 and 2 kHz and a throw distance of 1-2 mm was used.

The activator was inkjet printed in a variety of patterns, such as solid blocks, thin lines, text, checked patterns and standard inkjet printing test images.

After jetting of the activator solution, the printed activator solution was allowed to dry using an infra-red heater located just above the substrate. In some experiments, the printed catalyst solution was allowed to dry under ambient conditions, without any additional heating.

Where the infra-red heater was used, 30 seconds was found to be sufficient drying time.

Next, the 3 separate component solutions A, B and C were inkjet printed onto the dried activator. The three solutions were printed separately, in equal volumes, onto the same locations on the substrate, evenly across the whole printable surface area of the substrate, forming a reaction solution in situ. The solutions were inkjet printed using a 64ID3 print head, available from Ink Jet Technology. All parts of this print head which contact the fluid to be jetted are ceramic and so this head is particularly suitable for printing very basic or acidic liquids. Jetting took place at 5 kHz. The waveform of the potential applied to the piezoelectric printing head was selected to cause ejection of droplets of 137 pL.

The activator is reduced to form palladium particles on the surface which catalyse formation of a copper metal region thereon. Once copper has started depositing, the reaction is autocatalytic.

The reaction solution was allowed to remain in contact with the substrate until a suitable thickness of copper had been deposited. Typically, less than 5 minutes at room temperature were required to produce a suitable layer of copper.

It was found that the copper regions could be formed quicker by heating the substrate with infra-red radiation. However, it was important to ensure that the surface temperature did not rise above 50 degrees centigrade for many types of plastics substrates, to avoid warping the substrate.

Finally, any excess solution or dried salts were wiped or washed off the substrate, yielding a copper-plated sample where the copper plated regions correspond to the pattern in which the activator had been inkjet printed.

Results

Copper was inkjet printed by this technique onto the following substrates, and the strength of the adhesion between the deposited conductive metal regions and the substrate was qualitatively measured.

| Substrate Material | Adhesion |
|---|---|
| acrylic | Good |
| polystyrene | Good |
| polyethylene | Poor through good, |
| | depending on grade |
| delrin polyacetal homopolymer | Poor |
| Hostaform or Ultraform polyacetal copolymer | Poor |
| ABS (Acrylonitrile butadiene styrene) | Good |
| U-PVC | Good |
| silicone rubber | Poor |

(Delrin is a trademark of DuPont. Hostaform is a trademark of Hoechst. Ultraform is a trademark of BASF)

As a result we have demonstrated the printing of conductive metal regions with conductivity approximating that of bulk metal.

Metal layers of between 0.3 and 3 microns have been demonstrated depending on the specific chemistry used. Repeat printing can be used to build up thicker layers, such as the 15 to 20 micron layers required for aerial/antenna applications.

### EXAMPLE WITH 2 COMPONENT SOLUTIONS

In this example, a component solution, referred to as solution AB, contains both the metal ion and the reducing agent.

Solution AB

| | % - by weight |
|---|---|
| copper sulphate | 1.63 |
| sodium sulphate | 3.21 |
| EDTA disodium salt | 0.60 |
| formaldehyde solution (37% by weight in water) | 0.22 |
| sodium formate | 3.71 |
| water | 85.63 |
| t-butanol | 5.00 |

Solution AB was filtered through a 1 micron GF-B glass fibre filter, available from Whatman.

Deposition was carried out as before, beginning with inkjet printing of the catalyst solution followed by a delay while the activator solution solvent evaporated. Next, equal volumes of solution AB and solution C were inkjet printed over the surface of the substrate using the 64ID3 inkjet printhead.

As before, a conductive copper region was formed on the substrate.

### EXAMPLE WITH 1 COMPONENT SOLUTION

As a further alternative, the following single solution was prepared. It is stable for a period of a few hours and so may be inkjet printed as a single component solution.

| | % - by weight |
|---|---|
| Enplate 872 A | 24.09 |
| Enplate 872 B | 24.09 |
| Enplate 872 C | 8.03 |
| water | 13.29 |
| ethylene glycol | 20 |
| t-butanol | 5 |
| Surfadone LP-100 | 0.5 |
| PEG-1500 | 5 |

The above solution is prepared from its constituents and then filtered through a 1 micron GF-B glass fibre filter from Whatman. The viscosity is 9.8 cPs and the surface tension is 30.0 dynes/cm.

Enplate 872A contains copper sulphate. Enplate 872B contains a cyanide complexing agent and formaldehyde. Enplate 872C contains sodium hydroxide. (Enplate is a trade mark). Enplate 872 A, B and C are available from Enthone-OMI and are in common use as component solutions for electroless copper plating. Ethylene glycol is present as a humectant and acts to lower surface tension. T-butanol is a cosolvent which reduces surface tension and increases wetting. Surfadone LP-100 is a wetting agent with surfactant properties. PEG-1500 functions as a humectant.

The catalyst solution described above is inkjet printed according to a pattern. After a short pause (30 seconds) to allow the solvent in the activator solution to evaporate, the above solution is deposited by inkjet printing, either across the whole printable area of the substrate, or on top of the regions where the activator solution was inkjet printed. Thus, a copper layer forms on the surface of the substrate according to the pattern.

Alternative Activator Solution

The following activator solution can be used as an alternative to the activator solution given in the examples above.

| | % |
|---|---|
| palladium acetate | 2.0 |
| diacetone alcohol | 47.5 |
| methoxypropanol | 47.5 |
| polyvinylbutyral | 1.6 |
| polyvinylpyrollidinone | 1.4 |

This activator solution has a viscosity of 3.85 cPs and a surface tension of 30.5 dynes per cm.

K30 grade polyvinylpyrollidinone was sourced from International Speciality Products. This polymer has a molecule weight between 60,000 and 70,000 and was found to accelerate the formation of a conductive metal region but gave less reproducible results than with polyvinylbutyral.

1. A method of forming a conductive metal region on a substrate, comprising depositing on the substrate a solution of a metal ion, and depositing on the substrate a solution of a reducing agent, such that the metal ion and the reducing agent react together in a reaction solution to form a conductive metal region on the substrate.

2. A method according to claim 1, wherein the conductive metal which is formed on the substrate constitutes all, or the bulk of, the metal which is to form the conductive metal region in a finished product.

3. A method according to claim 1 or claim 2, wherein a pH altering reagent is also deposited on the substrate, to activate the reducing agent.

4. A method according to claim 1, wherein the composition of the reaction solution is selected so that it is sufficiently unstable that the reaction between metal ion and the reducing agent in solution to form the conductive metal region on the substrate takes place spontaneously but not so unstable that a fine powder of conductive metal forms spontaneously throughout the reaction solution, instead of forming a conductive metal region on the substrate.

5. A method according to claim 1, wherein the solution of metal ion and the solution of reducing agent are deposited in a plurality of separate component solutions.

6. A method according to claim 5, wherein the plurality of component solutions are deposited sequentially.

7. A method according to claim 5 or claim 6, wherein a single solution, or combination of solutions is allowed to partially or fully dry out, cure or otherwise harden before one or more further component solutions are deposited therein.

8. A method according to claim 5, wherein the reaction between the metal ion and the reducing agent in solution to form the conductive metal region on the substrate is activated by an activator.

9. A method according to claim 8, wherein the activator is a second conductive metal different from the first metal.

10. A method according to claim 9, wherein the second metal is formed by depositing ions of the second metal and a reducing agent on the substrate, such that the second metal ions and the reducing agent react together in a reaction solution to form a conductive metal region on the surface.

11. A method according to claim 8, wherein the activator has already been applied to the substrate.

12. A method according to claim 8, wherein the activator is a catalyst.

13. A method according to claim 8, wherein the metal ion, the reducing agent and a pH altering reagent are deposited in three separate component solutions which mix together on the substrate and form the reaction solution.

14. A method according to claim 8, wherein the metal ion and the reducing agent are deposited in a first component solution, and a pH altering reagent is deposited in second component solutions, such that the first and second component solutions mix together on the substrate and form the reaction solution.

15. A method according to claim 8, wherein the metal ion, the reducing agent and the pH altering reagent are deposited in a single solution.

16. A method according to claim 8, wherein the method includes the step of depositing the catalyst on the substrate before deposition of a component solution.

17. A method according to claim 16, wherein the activator is deposited before either or both of the metal ion or the reducing agent are deposited on the substrate.

18. A method according to claim 8, wherein the activator is deposited in an activator solution.

19. A method according to claim 18, wherein the solvent for the activator solution is primarily or entirely non-aqueous.

20. A method according to claim 18 or claim 19, wherein the solvent is allowed to substantially evaporate or otherwise dissipate prior to deposition of one or more component solutions.

21. A method according to claim 18, wherein the activator is deposited in a solution including a chemical component which promotes adhesion of the activator to the substrate.

22. A method according to claim 8, wherein the activator is an organic acid salt of a transition metal.

23. A method according to claim 18, wherein the activator is deposited in a solvent selected to partially dissolve the substrate to enable the activator to penetrate the substrate and improve adhesion of the resulting conductive metal region to the substrate.

24. A method according to claim 23, wherein the substrate is pretreated prior to the deposition of activator to improve adhesion.

25. A method according to claim 18, wherein the activator solution comprises one or more of the metal ion, the reducing agent or a pH altering reagent.

26. A method according to claim 5, wherein the component solution which comprises the metal ion further comprises a complexing agent.

27. A method according to claim 8, wherein the activator is deposited on the substrate in a pattern, thereby leading to the formation of one or more patterned conductive metal regions.

28. A method according to claim 27, wherein one or more component solutions is deposited in the same pattern, over the activator.

29. A method according to claim 5, wherein a pattern is formed by depositing a component solution in a pattern.

30. A method according to claim 1, wherein deposition in a pattern is carried out by inkjet printing.

31. A method according to claim 30, wherein an activator solution and one or more component solutions are inkjet printed.

32. A method according to claim 31, wherein substantially stochiometric amounts of metal ion and reducing agent are deposited.

33. A method according to claim 31, wherein an excess of reducing agent to metal ion is deposited, so that essentially all of the metal ion is consumed.

34. A method according to claim 30, in which the reaction solution or a component solution includes an acid or base, wherein the inkjet print head comprises a ceramic material such that liquid containing the acid or base contacts only ceramic material in the inkjet print head.

35. A method according to claim 1, wherein the conductive metal is selected from a group consisting of copper, nickel, silver, gold, cobalt, a platinum group metal, or an alloy of two or more of these materials.

36. A method according to claim 1, wherein the conductive metal includes non-metallic elements.

37. A method according to claim 1, wherein the metal ion is in the form of a salt.

38. A method according to claim 1, wherein the metal ion is present in a complex.

39. A method according to claim 1, where metal ions of a plurality of metals are deposited, thereby forming a region of a conductive metal alloy.

40. A method according to claim 1, wherein the substrate and/or the reaction solution are heated to start and/or speed up the process of deposition of conductive metal on the substrate.

41. A method according to claim 1, wherein the substrate is a material having thereon electric components.

42. A method according to claim 41, including the step of depositing one or more of said electrical components on a substrate prior to forming a conductive metal region on the resulting substrate.

43. A method according to claim 1, including the further step of depositing an electrical component onto the resulting conductive metal region, building up complex devices.

44. A method according to claim 1, wherein the method is repeated, depositing further metal ion and reducing agent in solution upon the conductive metal region so as to form a thicker conductive metal layer.

45. A method according to claim 44, wherein a different metal ion is used for a second or successive layers, thus building up a material comprising layers of a plurality of different metals.

46. A method according to claim 1, wherein a solution comprising a mixture of metal ions is deposited on the substrate, or a plurality of component solutions comprising different metal ions are deposited on the substrate, forming an alloy.

47. A method according to claim 1, wherein a composition of the reaction is initially deposited on the substrate and dried, cured or otherwise hardened to form a solid layer on the substrate, with one or more further component liquids subsequently deposited on the solid layer.

48. A method according to claim 47, wherein activator is initially deposited on the substrate and dried, cured or otherwise hardened to form a solid layer.

49. A method according to claim 48, wherein a solution of a reducing agent and a solution of a metal ion, preferably mixed together, are subsequently deposited on the solid layer comprising the activator.

50. A method of fabricating a radio frequency identification tag wherein a conductive metal region is deposited on a substrate by the method of claim 1.

51. A method according to claim 50, wherein the conductive metal region comprises an antenna.

52. A method of fabricating a radio frequency identification tag by depositing a conductive metal region on a substrate which comprises forming a battery on the substrate by forming depositing two regions of different conductive metals on the substrate by the method of claim 1, and electrolytically connecting the two regions by way of an electrolyte, thereby forming an electrochemical cell.

53. A method according to claim 52, wherein either or both conductive metal is deposited by inkjet printing metal ion and reducing agent.

54. A method according to claim 52, wherein the electrolyte is deposited by inkjet printing.

55. A method according to claim 50, wherein the conductive metal region comprises one or more electrical contacts of the microchip.

56. An article comprising a substrate including a conducting metal region prepared according to the method of claim 1.

57. A method of catalysing the reaction between a metal ion and a reducing agent to form a conducting metal region comprising the use of an organic acid salt of a transition metal as a catalyst.

58. A method according to claim 57, wherein the transition metal is palladium.

59. A method according to claim 58, wherein the organic acid salt is acetate, propanoate or butanoate.

60. A method according to claim 57, wherein the catalyst is deposited with a polymer to adhere the catalyst to the substrate.

61. A method according to claim 57, wherein the catalyst is applied to a substrate and the conducting metal region is formed as a layer on the substrate.

62. A method according to claim 57, wherein the catalyst is added to the substrate by inkjet printing a solution including the catalyst.
